(19) United States
(12) Patent Application Publication
(10) Pub. No.: US 2008/0185900 A1
(43) Pub. Date: Aug. 7, 2008

(54) USE OF RENEWABLE AND BIODEGRADABLE MATERIALS FOR AUTOMOTIVE INTERIORS

(76) Inventors: Ellen Cheng-ch Lee, Ann Arbor, MI (US); Cynthia Mowery Flanigan, Canton, MI (US); Kelly A. Williams, South Lyon, MI (US); Christine Perry, Gibraltar, MI (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/536,277

(22) Filed: Sep. 28, 2006

(51) Int. Cl. A47C 7/18; A47C 5/00; B29C 44/06

(52) U.S. Cl. 297/452.58; 264/46.5

(57) ABSTRACT

An automobile interior component including a support layer formed of a foam material and being generally covered by a cover layer, and a film layer generally disposed between the support and cover layers to prevent a selected portion of the foam material from directly contacting the cover layer during manufacture of the interior component, and/or allow placement of the cover layer on a selected portion of the support layer upon application of a vacuum within the film layer. The support, film and/or cover layers may be formed of biodegradable and/or renewable materials. The invention also provides a method of manufacturing the aforementioned automobile interior component.

### BACKGROUND OF INVENTION

a. Field of Invention

The invention relates generally to automotive interior components, and more particularly, to various soft or flexible automotive interior components formed with and utilizing renewable materials including polylactic acid and soy-based materials.

b. Description of Related Art

In order to minimize adverse impact on the environment, it is increasingly important for manufacturers of automobiles to search for ways to make their products “greener” and more environmentally friendly. One way to do so is to minimize the amount of material that finds its way to the junkyard at the end of an automobile's life cycle. These automobiles, often called “end-of-life vehicles” or “ELVs,” can become eyesores and environmental hazards if not built in a way to minimize the amount of material they leave behind. Additionally, various states as well as the European Union and Japan have passed increasingly stringent laws and regulations regarding end-of-life vehicles. It is therefore desirable for manufacturers of automobiles and automotive parts to build vehicular components out of recyclable, biodegradable, or otherwise “green” materials whenever possible. It is also desirable, from a customer relations standpoint, for manufacturers of automobiles and automobile parts to be able to advertise their products as being “green” or environmentally friendly.

To date, automobile headrests, seats, armrests and other automotive interior components are generally made utilizing at least two separate polymer components: a foamed polymer cushioning material, and a polymer sheeting material to separate the cushioning from the upholstery. The foam used is generally a polyurethane, while the sheeting may be any suitable polymer sheeting material such as PVC or LDPE. These materials can be difficult, and in some cases impossible, to recycle. Although technologies for recycling these materials are improving, it remains difficult to do so in an economically viable manner. That is, the cost of recycling these materials often exceeds the value of the recycled product. Therefore, these materials often end up in junkyards and landfills.

Given the difficulties in recycling materials currently used in vehicle seats and headrests, it is therefore desirable to develop a seat and headrest assembly that uses more earth-friendly, or “green,” materials. One way to do so is to use natural, biodegradable materials. Biodegradable materials will, upon disposal, begin to rapidly breakdown in an environmentally-friendly manner. Compared to conventional materials, biodegradable materials will be broken down by microorganisms and other processes much more quickly.

Another way to lessen the environmental impact of an automobile is to use materials which do not deplete non-renewable resources, such as fossil fuels. Most polymers are made from non-renewable petroleum products, the supply of which will eventually run out. Moreover, increasingly, environmentally-minded consumers demand and value products made from renewable resources.

A typical automobile seat construction is illustrated in U.S. Pat. No. 6,733,072 to Jaillet. Referring to FIG. 1 of Jaillet, a flexible film or sheeting (12) serves as a cast mold for separating liquid polyurethane precursors from the vehicle upholstery. The polyurethane precursors are poured into the film, which is formed in the shape of the cushion to be formed. The film material, therefore, must be non-soluble in the liquid precursor, as well as impermeable to it. Low air and moisture permeability also assist with product longevity. Although Jaillet discloses the use of “polysaccharides and animal proteins” for use in the film, it does not disclose use of a biodegradable film, nor does it disclose use of a biodegradable film in conjunction with a biodegradable cushioning material.

It is desirable, therefore, to maximize the use in automobiles of materials from natural, renewable resources. It is also desirable to design certain automobile components, especially those which cannot be otherwise easily recycled, using natural, biodegradable materials, and for such materials to be made from renewable resources, and to minimize the amount of fossil fuels needed for their manufacture. There is also a need to design components using such materials which may be used with existing components and assembly methods.

### SUMMARY OF THE INVENTION

The invention solves the problems and overcomes the drawbacks and deficiencies of prior art automobile interior component designs by providing an automobile interior component including a support layer formed of a foam material and generally covered by a cover layer, and a film layer generally disposed between the support and cover layers to prevent a selected portion of the foam material from directly contacting the cover layer during manufacture of the interior component, and/or to allow placement of the cover layer on a selected portion of the support layer upon application of a vacuum within the film layer. The support, film and/or cover layers may be formed of biodegradable and/or renewable materials.

For the automobile interior component described above, the support layer may contain a renewable foam material, which in an exemplary embodiment may be a soy polyol material. The film layer may be made of a predominately renewable material, which in an exemplary embodiment may be a polylactic acid (PLA) material or a polyhydroxy alkanoate (PHA) material. The support layer may be made of a predominately petroleum based foam material, and the film layer may be a polylactic acid (PLA) material or a polyhydroxy alkanoate (PHA) material. Moreover, the cover layer may be made of a predominately renewable material, and in a particular embodiment, the renewable material may be a polylactic acid (PLA) material or a polyhydroxy alkanoate (PHA) material.

The invention also provides a “pour in place” method of manufacturing an automobile interior component, with the method including the steps of forming a mold in the shape of the interior component, lining an interior of the mold with film and cover layers, filling the interior with a liquid foam material which substantially expands to fill the mold interior to form a support layer, and removing the support layer having the film and cover layers thereon from the mold interior. For the method described above, the support, film and/or cover layers may be formed of a biodegradable and/or renewable materials.

Yet further, the invention provides a “foam on stick” method of manufacturing an automobile interior component, with the method including the steps of forming a mold in shape of the interior component, lining an interior of the mold with a release agent, filling the interior with a liquid foam material which substantially expands to fill the mold interior to form a support layer, removing the support layer from the mold interior, substantially covering the support layer with a film layer, and substantially covering the support and film layers with a cover layer. For the method described above, the support, film and/or cover layers may be formed of a biodegradable and/or renewable materials.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an illustrative view of an automotive seat with a cutaway view showing an exemplary construction of the present invention;

FIG. 2 is a detailed illustrative view of the exemplary construction of FIG. 1;

FIGS. 3A-3D are illustrative views showing a method of assembly for a headrest, utilizing an exemplary construction according to the present invention; and

FIGS. 4A and 4B are illustrative views showing another method of assembly for a headrest, utilizing an exemplary construction according to the present invention.

### DETAILED DESCRIPTION OF THE PREFERRED EMBODIMENTS

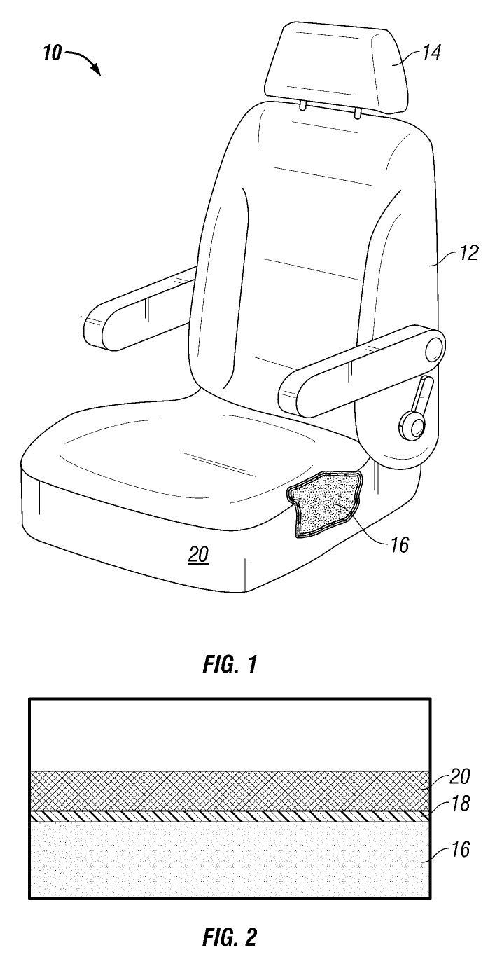

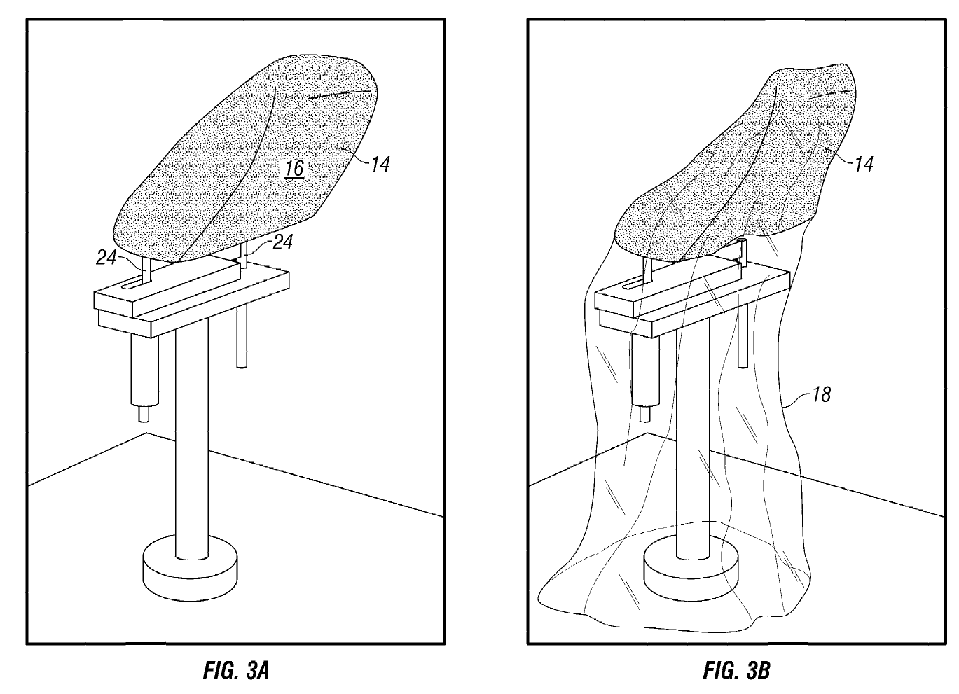

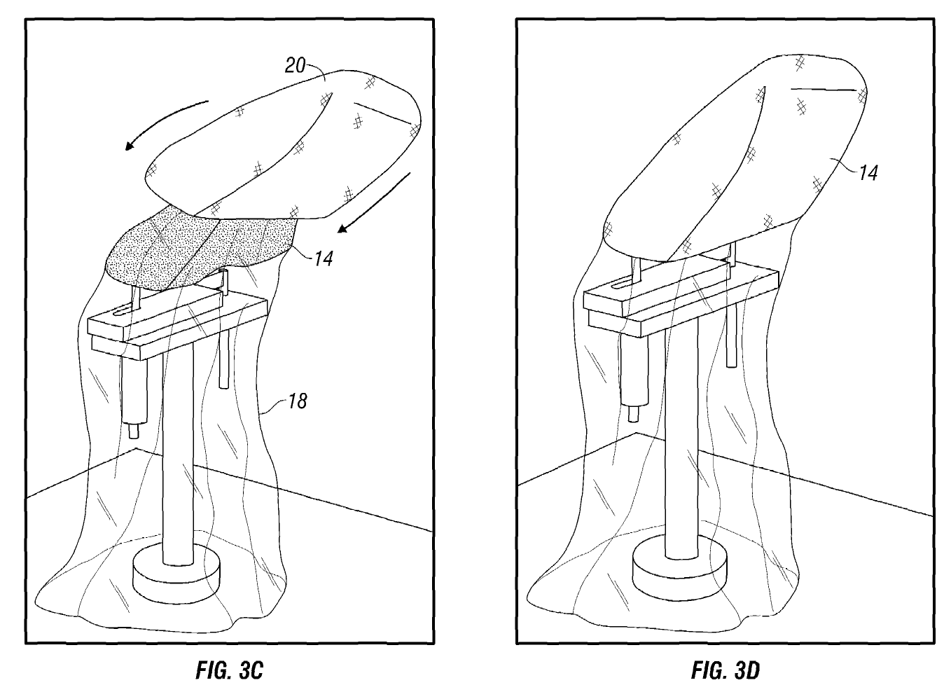

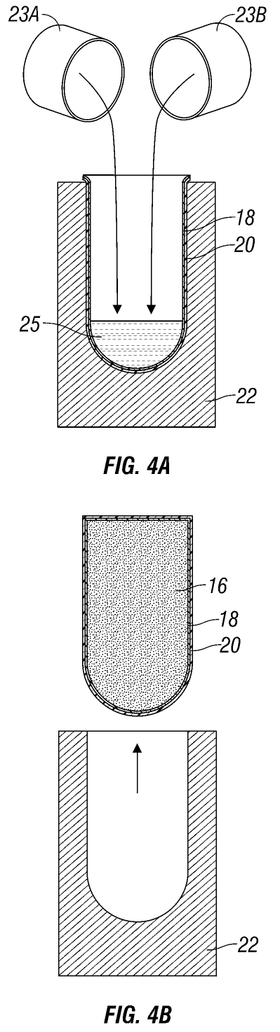

Referring now to the drawings wherein like reference numerals designate corresponding parts throughout the several views, FIGS. 1 and 2 illustrate an automotive seat with a cutaway view showing an exemplary construction of the present invention, and FIGS. 3A-4B illustrate exemplary methods of assembly for a headrest, utilizing exemplary construction methods according to the present invention.

Referring to FIGS. 1 and 2, according to the present invention, a soft automotive interior component 10, such as a seat 12, a headrest 14, or other soft components (i.e. the armrest, instrument panel etc.), may be formed as shown in FIG. 2 to include a base foam layer 16, an intermediate film layer 18 and a top cover layer 20. Film layer 18 may be provided to generally serve as an impermeable layer between foam layer 16 and cover layer 20 during manufacture of component 10. Once foam layer 16 is formed, film layer 18 may remain in place, but is primarily used during manufacture of component 10 as discussed in detail below.

Specifically, referring to FIGS. 3A-4B, component 10 may be manufactured, for example, by means of a “pour in place” or a “foam on stick/support” method.

Referring to FIGS. 4A and 4B, in the pour in place method, component 10 may be formed by pouring the liquid components of a sustainable/renewable soybean based material for forming foam layer 16 into a mold 22 (see FIG. 4A) having a sugar based film layer 18 and cover layer 20 disposed therein. In a particular embodiment of the present invention, soy based foam layer 16 may contain a soy polyol, sugar based film layer 18 may be formed primarily of polylactic acid (PLA) (which may be derived from a feedstock from which sugar can be extracted), and cover layer 20 may also be formed of a sustainable and renewable material, such as the PLA material used for forming film layer 18. In addition to being sustainable and renewable, PLA is also compostable to thus provide an environmentally friendly product in component 10. It should be noted that the terms sustainable, renewable and agricultural are interchangeably used herein to describe a material which may regenerate within a reasonable time period, for example, within five years. Referring to FIG. 4A, with mold 22 including film layer 18 and cover layer 20 disposed therein, foam layer precursors 23A and 23B may then be added to form a liquid reactant mixture 25. The liquid reactant mixture 25 may then polymerize and react to form a closed cell base foam layer 16. The finished assembly may then be removed from the mold as shown in FIG. 4B. Cover layer 20 may provide the final shape of the overall component, such as the seat or headrest, while film layer 18, as discussed above, may serve as an impermeable layer for preventing penetration of the liquid foam material (i.e. material 25 in FIG. 4A) into cover layer 20.

Referring to FIGS. 3A-3D, 4A and 4B, in the foam on stick/support method, the sustainable/renewable soybean based material for forming foam layer 16 may be foamed in mold 22 (see FIG. 4A) containing, for example, shafts 24 (see FIG. 3A) for a headrest assembly and/or other supports as needed for providing rigidity to an automotive interior component. Compared to the pour in place method described above, in the foam on stick method, instead of using film layer 18 and cover layer 20 disposed in the mold, the internal mold surface may be coated with a release agent for facilitating clean release of formed foam layer 16. Referring to FIG. 4A, with the internal surface of mold 22 coated with a release agent, foam layer precursors 23A and 23B may then be added to form a liquid reactant mixture 25. The liquid reactant mixture 25 may then polymerize and react to form a closed cell base foam layer 16. The finished assembly may then be removed from the mold as shown in FIG. 4B.

Once foamed in the mold and removed as in FIG. 4B, as shown in FIGS. 3B-3D, the base foam may then be covered with a plastic bag forming film layer 18. With a vacuum then applied to contract the foam in the bag as shown in FIG. 3B, cover layer 20 may then be placed over the assembly as shown in FIG. 3C, with the final assembly shown in FIG. 3D. For FIG. 3D, the vacuum may then be released, allowing foam layer 16 to resume its full shape and fill out cover layer 20. As readily evident, any excess material for cover layer 20 or film layer 18 may be trimmed and discarded as needed after placement of cover layer 20 on the headrest.

For the exemplary headrest application discussed above, the polylactic acid film layer 18 may need only serve the purpose of providing an impermeable layer during the aforementioned manufacture/assembly process, after which, layer 18 may be allowed to biodegrade in a period shortly after completion of the manufacture/assembly process. Alternatively, layer 18 may remain in use in a vehicle without any adverse affects, and may be allowed to biodegrade at the end-of-life stage for a vehicle.

Those skilled in the art would readily appreciate in view of this disclosure that various modifications could be made to the biodegradable and renewable automotive interior component 10 described above, without departing from the scope of the present invention. For example, instead of using a soy based foam layer 16, component 10 may include only a sugar based film layer 18 for providing at least partial biodegrading and renewability capabilities, and a conventional petroleum based polyurethane foam. Moreover, as discussed above, while soy based foam layer 16 may contain soy polyol, and sugar based film layer 18 may be formed primarily of polylactic acid (PLA) or polyhydroxy alkanoate (PHA), other legumes including similar biodegradable and renewable properties as soy based foam layer 16 and film layer 18 (made of a renewable/agriculturally grown material) may be used instead to provide a biodegradable and renewable component 10. For example, the soy based foam layer 16 may be formed from other vegetables or seeds, including for example, palm oil, grape seeds etc. The polymer material for the aforementioned film, cover and/or foam layers may be derived from an agricultural based process which yields sugar, which is then processed to fermentation or polymerization to produce the film, cover or the foam layers.

To summarize, use of soy based foam layer 16 and sugar based film layer 18 in component 10 allows natural and renewable resources to be used in automobiles. Soy based foam layer 16 and sugar based film layer 18 also allows for design of certain automobile components, especially those which cannot be otherwise easily recycled, using natural, biodegradable materials, and further allows use of such materials with existing manufacturing and assembly methods.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An automobile interior component comprising:
a support layer formed of a foam material and being generally covered by a cover layer; and
a film layer being generally disposed between said support and cover layers to at least one of prevent a selected portion of said foam material from directly contacting said cover layer during manufacture of said interior component, and allow placement of said cover layer on a selected portion of said support layer upon application of a vacuum within said film layer,
wherein at least one of said support, film and cover layers is formed of at least one of biodegradable and renewable materials.

2. An automobile interior component according to claim 1, wherein said support layer contains a renewable foam material.

3. An automobile interior component according to claim 2, wherein said renewable foam material is a soy polyol material.

4. An automobile interior component according to claim 1, wherein said film layer is made of a predominately renewable material.

5. An automobile interior component according to claim 4, wherein said renewable material is one of a polylactic acid (PLA) material and a polyhydroxy alkanoate (PHA) material.

6. An automobile interior component according to claim 1, wherein said support layer is made of a predominately petroleum based foam material, and said film layer is one of a polylactic acid (PLA) material and a polyhydroxy alkanoate (PHA) material.

7. An automobile interior component according to claim 1, wherein said cover layer is made of a predominately renewable material.

8. An automobile interior component according to claim 7, wherein said renewable material is one of a polylactic acid (PLA) material and a polyhydroxy alkanoate (PHA) material.

9. A method of manufacturing an automobile interior component, said method comprising the steps of:
forming a mold in shape of the interior component;
lining an interior of the mold with film and cover layers;
filling the interior with a liquid foam material which substantially expands to fill the mold interior to form a support layer; and
removing the support layer having the film and cover layers thereon from the mold interior,
wherein at least one of the support, film and cover layers is formed of at least one of biodegradable and renewable materials.

10. A method according to claim 9, wherein said support layer contains a renewable foam material.

11. A method according to claim 10, wherein said renewable foam material is a soy polyol material.

12. A method according to claim 9, wherein said film layer is made of a predominately renewable material.

13. A method according to claim 12, wherein said renewable material is one of a polylactic acid (PLA) material and a polyhydroxy alkanoate (PHA) material.

14. A method according to claim 9, wherein said support layer is made of a predominately petroleum based foam material, and said film layer is one of a polylactic acid (PLA) material and a polyhydroxy alkanoate (PHA) material.

15. A method of manufacturing an automobile interior component, said method comprising the steps of:
forming a mold in shape of the interior component;
lining an interior of the mold with a release agent;
filling the interior with a liquid foam material which substantially expands to fill the mold interior to form a support layer;
removing the support layer from the mold interior;
substantially covering the support layer with a film layer; and
substantially covering the support and film layers with a cover layer,
wherein at least one of the support, film and cover layers is formed of at least one of biodegradable and renewable materials.

16. A method according to claim 15, wherein said support layer contains a renewable foam material.

17. A method according to claim 16, wherein said renewable foam material is a soy polyol material.

18. A method according to claim 15, wherein said film layer is made of a predominately renewable material.

19. A method according to claim 18, wherein said renewable material is one of a polylactic acid (PLA) material and a polyhydroxy alkanoate (PHA) material.

20. A method according to claim 15, wherein said support layer is made of a predominately petroleum based foam material, and said film layer is one of a polylactic acid (PLA) material and a polyhydroxy alkanoate (PHA) material.
